(19) United States
(12) Patent Application Publication
(10) Pub. No.: US 2007/0189137 A1
(43) Pub. Date: Aug. 16, 2007

(54) Rotating disk storage device and recording method

(75) Inventors: Takahiro Saito, Kanagawa (JP); Takayuki Yamaguchi, Kanagawa (JP); Atsushi Kanamaru, Kanagawa (JP); Wataru Ichihara, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., Amsterdam (NL)

(21) Appl. No.: 11/652,387

(22) Filed: Jan. 10, 2007

(30) Foreign Application Priority Data
Jan. 10, 2006 (JP) 2006-002057

(51) Int. Cl. G11B 20/10

(52) U.S. Cl. 369/47.32; 369/53.31

(57) ABSTRACT

Embodiments in accordance with the present invention provide methods to record, in a rotating disk storage device, a data block in the unit of a logical sector on a recording medium on which a physical sector including a plurality of logical sectors is formatted. Extra addresses are acquired in a buffer to record write data blocks transferred from a host device. Data blocks are read from the recording medium in the unit of a physical sector. A skip read section discards data blocks having the same data blocks as the write data blocks by removing them from the read data blocks, and sends the remaining data blocks to the buffer. The buffer stores the data blocks in the order of recording in a physical sector.

### CROSS-REFERENCES TO RELATED APPLICATIONS

The instant nonprovisional patent application claims priority to Japanese Patent Application 2006-002057, filed Jan. 10, 2006 and incorporated by reference herein for all purposes.

### BACKGROUND OF THE INVENTION

Embodiments in accordance with the present invention relate to a technology for recording data in a logical sector, which is a part of a physical sector, in a rotating disk storage device that accesses in the unit of a physical sector, which includes a plurality of logical sectors.

A magnetic disk drive, which is an example of a rotating disk storage device, is a direct-access storage device that can read/write data in the unit of a physical sector, which generally includes a 512-byte data block and incidental information about such a data block. On the other hand, an operating system of a host device manages files in the unit of a cluster, which includes a plurality of logical sectors. Therefore, when the host device accesses the magnetic disk drive, it specifies a logical sector address.

In recent years, the magnetic disk drive is also used as an audio/video recording/playback device that handles large data files. It is therefore desirable to further increase the storage capacity of the magnetic disk drive. In order to access a magnetic disk in the unit of a physical sector, the magnetic disk drive adds incidental information such as a preamble, address information, ECC, and postamble to each physical sector in addition to a data block that stores user data. These items of incidental information narrow the user data recording region on the recording surface of the magnetic disk and decrease the recording density per unit area.

It is conceivable that the recording density per unit area may be increased by reducing the area occupied by the incidental information in contrast to the area occupied by the data block. In such an instance, the length of the data block is increased from 512 bytes to 1 kilobyte or 4 kilobytes to enlarge the physical sector. Meanwhile, the operating systems such as Windows (registered trademark) manage files in the unit of a cluster, which is an compatible with a large number of computers into which one of the above-mentioned operating systems is incorporated, it is therefore necessary that the magnetic disk drive be directly accessible in the unit of a 512-byte logical sector.

If the physical sector data block length is equal to the logical sector data block length, the magnetic disk drive can record data in the unit of a physical sector upon receipt of a write command for a specific logical sector from the host device. However, if the logical sector data block length is shorter than the physical sector data block length, the magnetic disk drive cannot directly record data in the unit of a logical sector upon receipt of a write command for a specific logical sector from the host device.

Japanese Patent Laid-Open No. 289821/1993 discloses a method for performing a high-speed write from an external input device to a magnetic disk drive in which the physical sector length differs from the logical sector length. The method disclosed by Japanese Patent Laid-Open No. 289821/1993 determines the access data length in accordance with the data stored in a data buffer and the data transferred from the external input device, performs a write, and reduces the rotational delay.

When a noncontiguous region such as a zone boundary exists in a recording region of an optical disk into which received data is to be recorded, the technology disclosed by Japanese Patent Laid-Open No. 106143/1998 writes the data positioned immediately before the noncontiguous region by performing a single write operation. When the write data for the trailing contiguous regions of the optical disk is received from the host device, this technology writes the data remaining in a cache memory after the write onto the optical disk together with the received data. As a result, the data positioned subsequently to the noncontiguous region is recorded together with the data receiver later. Consequently, the rotational delay of the optical disk is minimized at the time of data recording.

If the logical sector data block length is shorter than the physical sector data block length, a single physical sector contains a plurality of logical sectors. When the host device updates data recorded in some logical sectors within a physical sector in which data is already recorded, the physical sector contains logical sectors that become updated and logical sectors that remain unupdated. However, the magnetic disk drive can merely record data on the magnetic disk in the unit of a physical sector. Therefore, it is necessary to read data blocks that remain unupdated from the magnetic disk and then write the data blocks for all logical sectors constituting a physical sector at once. that remain unupdated from the magnetic disk and then write the data blocks for all logical sectors constituting a physical sector at once.

### BRIEF SUMMARY OF THE INVENTION

Embodiments in accordance with the present invention provide methods to record, in a rotating disk storage device, a data block in the unit of a logical sector on a recording medium on which a physical sector including a plurality of logical sectors is formatted. Referring to the particular embodiment shown in FIG. 3, extra addresses #004, #005, #0026, and #0027 are acquired in a buffer 17 to record write data blocks (LBAs 10 to 29) transferred from a host device. Data blocks (LBAs 08 to 31) are read from the recording medium in the unit of a physical sector. A skip read section 29 discards data blocks (LBAs 10 to 29) having the same LBAs as the write data blocks by removing them from the read data blocks, and sends the remaining data blocks to the buffer. The buffer stores the data blocks in the order of recording in a physical sector.

For a more complete understanding of the present invention, reference is made to the following detailed description taken in conjunction with the accompanying drawings.

### BRIEF DESCRIPTION OF THE DRAWINGS

FIG. 1 is a schematic block diagram illustrating a magnetic disk drive according to an embodiment of the present invention.

FIGS. 2(a) and 2(b) illustrate the format of a physical sector and the format of a logical sector according to an embodiment of the present invention.

FIG. 3 shows a data flow for a data write according to an embodiment of the present invention.

FIG. 4 is a flowchart illustrating a data write method according to an embodiment of the present invention.

FIGS. 5(a) and 5(b) illustrate another data write method according to an embodiment of the present invention.

invention is to provide a rotating disk storage device, which is equipped with a recording medium that is formatted on the basis of a physical sector including a plurality of logical sectors, and capable of writing data at a high transfer speed. Still another object of an embodiment of the present invention is to provide a data recording method for use in the above-mentioned rotating disk storage device.

Embodiments in accordance with the present invention provide a technology for recording a data block into some of the logical sectors constituting a physical sector in a rotating disk storage device that accesses in the unit of a physical sector in a situation where a physical sector includes a plurality of logical sectors. A write data block generally comprises a plurality of data blocks and includes a first data block, which has a first address, and a last data block, which has a last address. It should be noted, however, that embodiments in accordance with the present invention are also effective for recording a data block whose first data block has the same address as the last data block.

When a data block is to be recorded in a logical sector, which is a part of a physical sector, the data block to be recorded newly and the previously recorded data blocks that are not to be updated need to be arranged in a physical sector format. Embodiments in accordance with the present invention use a buffer to provide data block arrangement in accordance with the physical sector format.

In one embodiment of the present invention, the buffer stores a write data block that is transferred from the host device. The buffer also stores a leading data block that is read from a physical sector containing a first logical sector, which stores a first data block, and recorded in a leading logical sector positioned before a logical sector in which the first data block is recorded. Control means exercises control so that the leading data block and write data block are arranged in the buffer in the order of recording in the physical sector. As a result, when the data blocks in some of the logical sectors constituting a physical sector are to be recorded or updated, it is possible to sequentially read the data blocks from the buffer and formulate the physical sector format together with the remaining data blocks for recording purposes.

When a write operation is performed, the buffer stores a write data block earlier than a read data block. Therefore, if an extra address is acquired before the first data block, data blocks can be arranged in the buffer in the order of recording in a physical sector when the leading data block to be stored in the buffer subsequently is stored at the extra address. Similarly, if the extra address is acquired after the last data block and the trailing data block to be stored subsequently in the buffer is recorded as the extra address, the order of recording in the physical sector can be maintained even when another data block is stored in the buffer before the trailing data block is stored in the buffer.

The read data block read from the physical sector contains a data block that is read from an address at which the write data block is to be recorded. However, these data blocks are not included in a physical sector format for a rewrite. Therefore, when such data blocks are discarded in the skip read section, unnecessary data blocks will not be stored in the buffer. Further, if an extra address is acquired before the first data block and after the last data block, data blocks can be arranged in the buffer in the order according to a physical sector format simply when data blocks passing through the skip read section are sequentially stored in the buffer that stores the write data block. When data blocks are to be arranged in the buffer in the order of recording in the physical sector, it is possible to store the write data block and all the read data blocks in the physical sector in the buffer and then overwrite the write data block at a buffer address at which a read data block having the same LBA as the write data block is stored.

According to another embodiment of the present invention, the buffer stores a write data block and a read data block that is read from a physical sector containing a logical sector whose address is specified by the host device. If the address of the write data block is the same as that of the read data block, the write data block and read data block are sequentially read from the buffer in the order of recording in the physical sector while giving priority to the write data block. In this embodiment of the present invention, address management is exercised so that the write data block and read data block are sequentially stored in the buffer in the order of arrival, and that when data blocks are to be read from the buffer for recording on the recording medium, they are arranged in the order of recording in the physical sector.

Embodiments in accordance with the present invention provide a rotating disk storage device, which is equipped with a recording medium that is formatted on the basis of a physical sector including a plurality of logical sectors, and capable of writing data in the unit of a logical sector. Further, embodiments of the present invention provide a rotating disk storage device, which is equipped with a recording medium that is formatted on the basis of a physical sector including a plurality of logical sectors, and capable of writing data at a high transfer speed. Furthermore, embodiments of the present invention provide a data recording method for use in the above-mentioned rotating disk storage device.

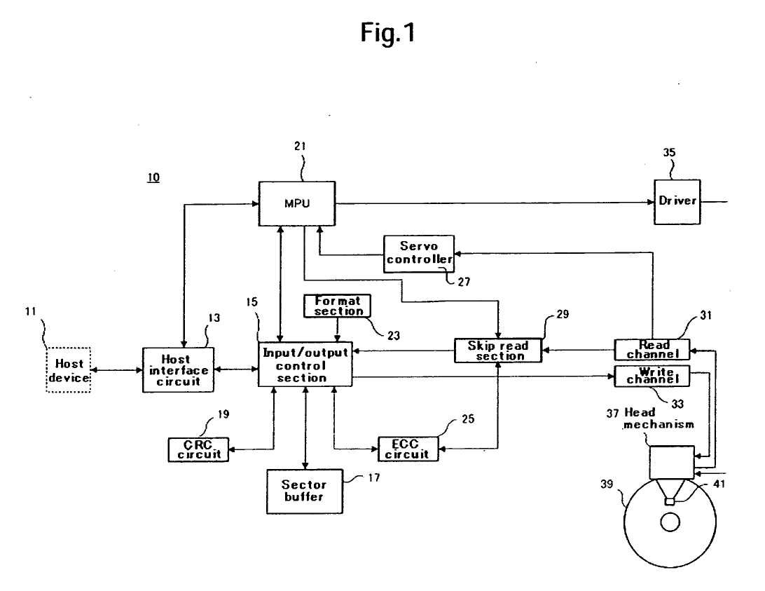

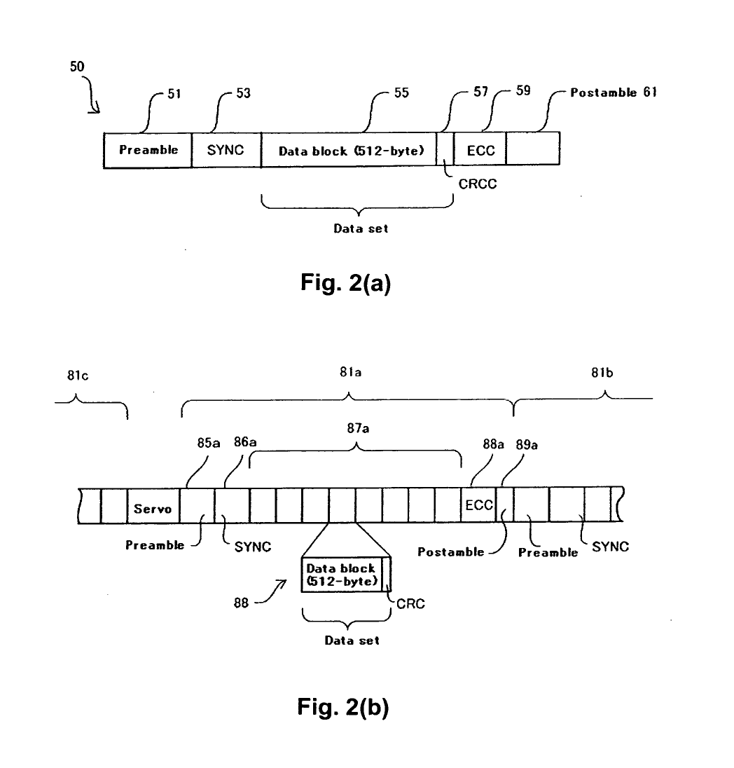

FIG. 1 is a schematic block diagram illustrating a magnetic disk drive 10 according to an embodiment of the present invention. FIGS. 2(A) and 2(B) illustrate the format of a magnetic disk 39. FIG. 2(A) shows the format of a general data sector 50 in which a physical sector coincides with a logical sector. The data sector 50 includes a preamble 51, a sync code (SYNC) 53, a data block 55, a CRCC 57, an ECC 59, and a postamble 61. The preamble 51 is made of 20 bytes and used to achieve synchronization between a read-clock phase and frequency on a bit-by-bit basis before a user data read. The SYNC 53 is a special pattern different from an RLL (Run Length Limited) method pattern, and used to acquire the start position of the data block 55. The data block 55 is a 512-byte storage region for recording user data that is modulated by an RLL method.

In the present embodiment, the CRCC 57 is a 4-byte error detection code, and the ECC 59 is a 59-byte error correction code. The postamble 61 is made of 5 bytes, and used to terminate a maximum likelihood process when an information read method called “PRML,” which is a combination of a partial response method and maximum likelihood method, is used. As described above, one data sector 50 comprises a data block and incidental information, and the physical sector and logical sector units accessible by the magnetic disk drive are equal to the data sector 50. In this document, a set of the data block 55 and CRCC 57 is referred to as a data set.

FIG. 2(B) shows the format of the magnetic disk 39 that is used in the magnetic disk drive 10 according to the present embodiment. The magnetic disk drive 10 uses a data plane servo scheme so that one or a plurality of physical sectors 81c, 81a, 81b are positioned between servo data on a circular data track. Each physical sector comprises a preamble 85a, a SYNC 86a, a logical sector group 87a that includes eight logical sectors 88, an ECC 88a, and a postamble 89a. Logical block addresses (hereinafter referred to as LBAs), which begin with No. 0, are sequentially assigned to the logical sectors 88 on the entire recording surface of the magnetic disk 39. As is the case with the data sector 50, a data set comprising a 512-byte data block and CRCC is recorded in the logical sector 88. However, since the logical sector 88 does not contain a preamble, SYNC, or other incidental information, it cannot be directly accessed to perform a write or read operation.

LBAs are sequentially assigned to the logical sectors constituting each physical sector in the order of reading/writing by the magnetic head. Since each physical sector includes eight logical sectors 88, the LBAs of logical sectors that are first accessed within a physical sector are 0, 8, 16, and so on, that is to say, multiples of 8. Therefore, the magnetic disk drive can identify the address of each physical sector in accordance with the LBA of the first-accessed logical sector. When the employed format is such that each physical sector includes a plurality of logical sectors, access for a read or write operation is gained in the unit of a physical sector. However, the ratio of the number of incidental information bytes to the number of data block bytes can be decreased to increase the data recording density.

In this document, the terms “physical sector” and “logical sector” denote the format of the magnetic disk, whereas the term “data block” denotes an aggregate of unit data stored in each logical sector. The term “LBA” denotes a magnetic disk address that is assigned to a physical sector or logical sector. However, the data block and data set to be stored in a logical sector may be indicated by the LBA of a logical sector in which the data block and data set are to be stored or by the LBA of a logical sector in which the data block and data set are stored.

Returning to FIG. 1, the magnetic disk drive 10 is connected to the host device 11 such as a computer or video recording/playback device. In the host device 11, the operating system manages files in the unit of a cluster that includes a plurality of 512-byte data blocks, and accesses the magnetic disk drive 10 in the unit of a cluster to perform a read or write operation. When writing data blocks, the host device 11 specifies the LBA of the logical sector to be written and the number of logical sectors, and transfers a group of data blocks to the magnetic disk drive.

A host interface circuit 13 is an ATA circuit that provides control over data communication between the host device 11 and magnetic disk drive 10. Data, commands, and control information input/output operations are performed between the host device 11 and magnetic disk drive 10 via the host interface circuit 13. When writing data into the magnetic disk drive 10 or reading data from the magnetic disk drive 10, the host device 11 accesses an ATA register that is assigned to the host interface circuit 13.

An input/output control section 15 exercises data input/output control over a sector buffer 17, a CRC circuit 19, and an ECC circuit 25. Further, the input/output control section 15 manages the address of the data to be stored in the sector buffer 17 on a first-in, first-out (FIFO) basis. When data is to be written onto the magnetic disk 39, the input/output control section 15 also generates a physical sector format that includes incidental information and data set. The sector buffer 17 is an 8-megabyte SDRAM. The sector buffer 17 exercises a read cache function and write cache function in order to absorb the difference between the processing speed prevailing inside the magnetic disk drive 10 and the speed of transfer relative to the host device 11 for transfer rate enhancement. Further, the sector buffer 17 is used to implement a data block write method according to the present embodiment. More specifically, the sector buffer 17 is used as a storage region for arranging the write data block transferred from the host device 11 and the data block read from the magnetic disk 39 for record retention in the order according to the physical sector format. The sector buffer 17 will be described in detail later.

A format section 23 generates a preamble, SYNC, postamble, and other incidental information to be added to each physical sector, and sends them to the input/output control section 15. The CRC circuit 19 uses a generator polynomial based on the cyclic redundancy check (CRC) method to generate a CRCC for each data block transferred from the host interface circuit 13 to the input/output control section 15. In the present embodiment, the CRCC is calculated for each 512-byte data block, which corresponds to the unit of logical sector storage, and composed of four bytes. The input/output control section 15 formulates data sets, each of which is a set of a 512-byte data block and a 4-byte CRCC, and controls the sector buffer 17 so as to store each data set at a predetermined address of the sector buffer 17.

Before a data block transmission to the host device 11 and before a data block write onto the magnetic disk 39, the CRC circuit 19 uses a generator polynomial to check for a bit inversion error in each data set that is loaded from the sector buffer 17 to the input/output control section 15. When a write operation is performed, the ECC circuit 25 uses the reed solomon method to generate an ECC 88a for eight data sets recorded in a physical sector that is read from the sector buffer 17 and formulated by the input/output control section 15. The larger the number of ECC bytes, the higher the error correction capability. If it is presumed that a physical magnetic disk defect is not likely to occur in the entire physical sector, the same substantial error correction capability can be maintained while the number of bytes of ECC 88a is rendered smaller than eight times the number of bytes of ECC 59 in a conventional logical sector 50.

The ECC circuit 25 calculates an error syndrome for each of eight sets of a data set and ECC, which are loaded from the read channel 31 to the skip read section 29 during a read operation, and checks for a bit inversion error in the eight data sets. If the detected bit inversion error is within the correction capability, the ECC circuit 25 corrects a data set bit value.

In compliance with instructions from an MPU 21, the skip read section 29 discards a data set having the LBA of the write data block by removing it from the eight data sets sent from the read channel 31 and sends the remaining data sets to the input/output control section 15 during a data recording process according to the present embodiment. The operation of the skip read section 29 will be described in detail later.

The read channel 31 processes the data read from the magnetic disk 39 in the unit of a physical sector 81c, 81a, 81b (see FIG. 2(B)), and sends the processed data to the skip read section 29. Further, the read channel 31 processes the servo data read from the magnetic disk 39 and sends the processed servo data to a servo controller 27. A write channel 33 receives data, which is formatted in the same manner as in the physical sector 81a, from the input/output control section 15, processes the received data, and sends the processed data to a head mechanism 37.

The head mechanism 37 includes a magnetic head 41 and a carriage mechanism that places the magnetic head at a specified position above the magnetic disk 39. The MPU 21 includes a processor, a RAM, an EEPROM, and a firmware storage ROM, and controls the read or write operation of the magnetic disk drive 10. The MPU 21 interprets a command that is written into an ATA register of the host interface circuit 13 by the host device 11 and controls the operation of the magnetic disk drive 10. In accordance with an LBA that is sent from the host device 11 together with a write command, the MPU 21 sends a signal to a driver 35 and controls the head mechanism 37 to position the magnetic head above a physical sector having a specified LBA. The MPU 21 calculates an address at which the data block transferred from the host device 11 is stored in the sector buffer 17 and informs the input/output control section 15 of the calculated address. The MPU 21 controls the skip read section 29 so as to discard a data set having the same LBA as the write data set by removing it from the read data set that is read for data recording purposes. The address calculation of the sector buffer 17 and the control of the skip read section 29 will be described in detail later.

The servo controller 27 processes the servo information that is received from the read channel 31, and sends the position information about the magnetic head 41 to the MPU 21. In accordance with the position information sent from the servo controller 27, the MPU 21 generates a control signal that corresponds to the amount of head mechanism operation and sends the generated control signal to the driver 35. The driver 35 generates a control current for placing the magnetic head 41 at a position specified by the MPU 21 and sends the generated control current to the head mechanism 37. Many other known elements are required to construct the magnetic disk drive 10. However, they are not described here because they are not particularly relevant to the present invention. The functional block shown in FIG. 1 is prepared as an example. A person of ordinary skill in the art would understand that some of the functions described with reference to FIG. 1 can be incorporated into a single semiconductor device or further divided.

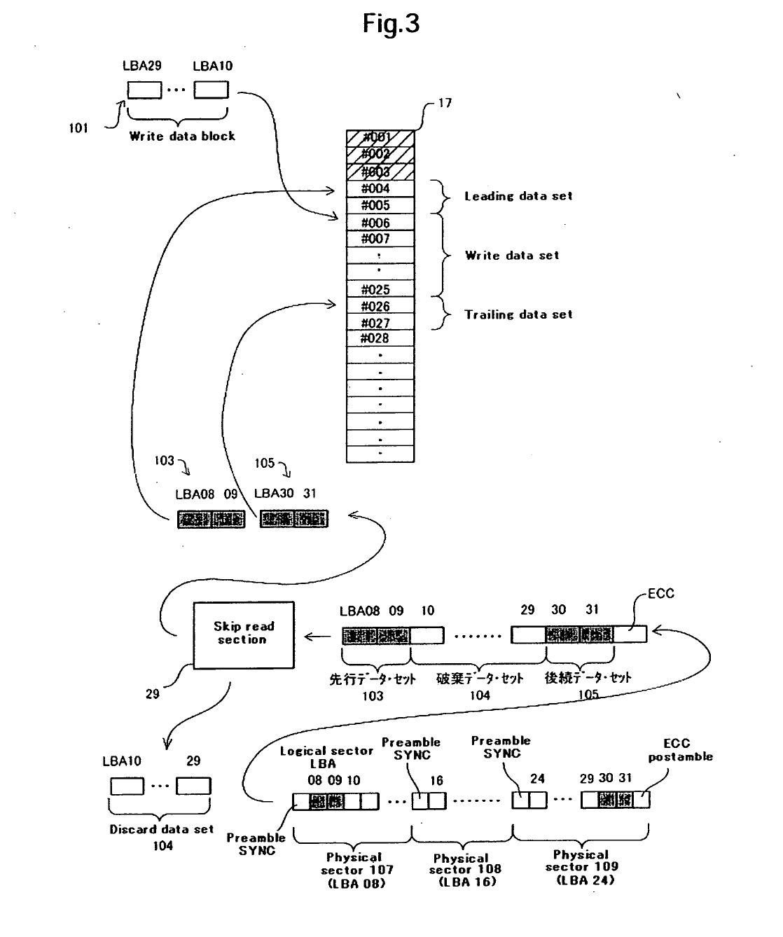

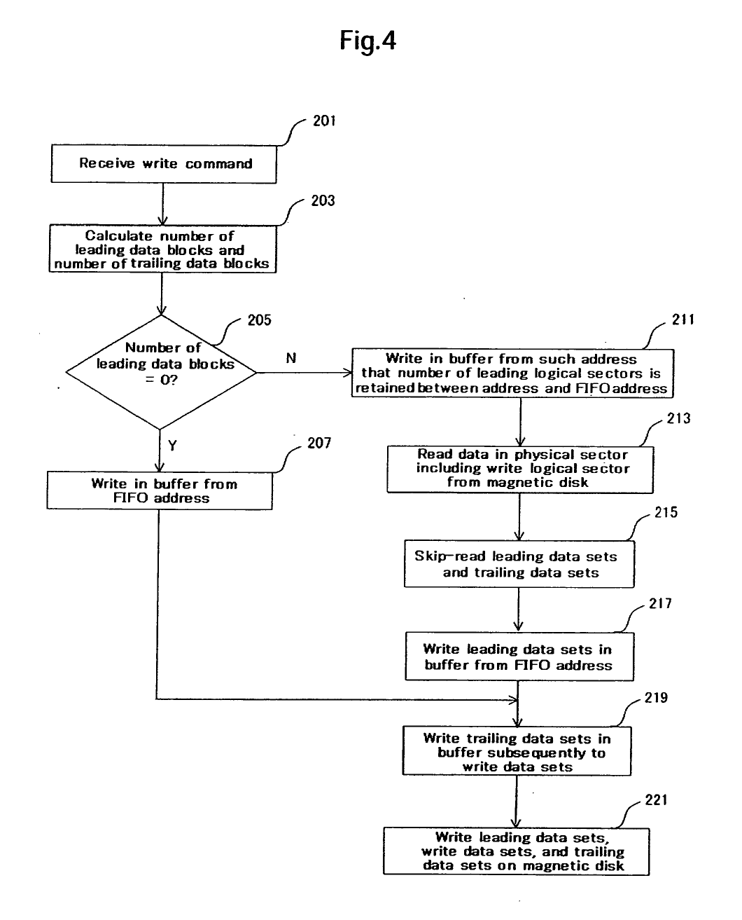

The method for writing data in a logical sector, which is a part of a physical sector, within the magnetic disk drive 10 will now be described with reference to FIGS. 3 and 4. The present invention relates to a situation where the logical sectors whose addresses are specified by the host device 11 include logical sectors that are used to write data within the same physical sector and logical sectors that are used to maintain written data without writing data. Such a physical sector may be a physical sector containing the first logical sector and a physical sector containing the last logical sector or either of these physical sectors in a situation where a single write command specifies the LBAs of a plurality of contiguous logical sectors.

FIG. 3 shows a data flow for a data write. FIG. 4 is a flowchart illustrating a write procedure. Referring to FIG. 3, the magnetic disk 39 stores data blocks. The data blocks are stored in physical sectors 107, 108, 109, which are in the same format as the physical sector 81a shown in FIGS. 2(A) and 2(B). A total of 24 logical sectors, which are arranged in the order of accessing by the magnetic head 41 and assigned LBAs 08 to 31, are contained in the physical sectors 107, 108, 109. It is assumed that the host device 11 manages files in accordance with a cluster that includes 5 logical sectors, and that the write data block 101 for writing 20 LBAs (LBAs 10 to 29) corresponding to 4 clusters is written on the magnetic disk 39. As regards the write data blocks 101, it is assumed that the LBA of the first-written data block (hereinafter referred to as the first data block) is 10, and that the LBA of the last-written data block (hereinafter referred to as the last data block) is 29. It is also assumed that, within a physical sector, a logical sector in which the first data block is written is referred to as the first logical sector, and that a logical sector in which the last data block is written is referred to as the last logical sector.

Logical sectors whose LBAs range from 10 to 29 begin in physical sector 107 and end in physical sector 109. No write data block 101 is written in logical sectors having LBAs 08 and 09, therefore, the previously written data needs to be maintained. This also holds true for logical sectors having LBAs 30 and 31 in physical sector 109.

Data can be written in the magnetic disk drive 10 in the unit of a physical sector only. To write data sets in the logical sectors of physical sectors 107 and 109, therefore, it is necessary to set the data sets corresponding to all the logical sectors constituting the physical sectors in a physical sector format and then write them at the same time. More specifically, it is necessary to read from the magnetic disk 39 the data blocks of logical sectors having LBAs 08 and 09 (hereinafter referred to as the leading logical sectors), which precede the first logical sector (LBA 10) in physical sector 107, and the data blocks of logical sectors having LBAs 30 and 31 (hereinafter referred to as the trailing logical sectors), which succeed the last logical sector (LBA 29) in physical sector 109, and formulate a format for writing into a physical sector together with the write data block 101.

In this document, it is assumed that the leading logical sector and trailing logical sector are contained in the same physical sector and a logical sector preceding the first logical sector and a logical sector succeeding the last logical sector, respectively. It is also assumed that a data block or data set corresponding to the leading logical sector is a leading data block or leading data set. This also holds true for the trailing logical sector.

In step 201, the host device specifies a write command, the LBA of the first data block, and the total number of data blocks 101, and sends the data blocks 101 to the host interface circuit 13. The MPU 21 controls the head mechanism 37 so as to place the magnetic head 41 above physical sector 107, which contains the first logical sector (LBA 10), in order to write the data blocks 101.

In step 203, the MPU 21 calculates the number of leading logical sectors concerning physical sector 107 and the number of trailing logical sectors concerning physical sector 109, and sends the calculation results to the input/output control section 15. In the present embodiment, two leading logical sectors (LBAs 08 and 09) arise in physical sector 107, and two trailing logical sectors (LBAs 30 and 31) arise in physical sector 109. It is assumed that a data set is already stored at addresses #001 to #003 of the sector buffer 17, and that the input/output control section 15 exercises management while assuming that the address to be used next, which is determined in accordance with a FIFO algorithm and hereinafter referred to as the FIFO address, is #004.

In step 205, the MPU 21 judges whether the number of leading logical sectors is zero. If the number of leading logical sectors is zero, step 207 is performed to store a data set corresponding to the write data block 101 in the sector buffer 17 beginning with the FIFO address (#004). The data set includes a CRCC that is generated by the CRC circuit 19 for each of 20 data blocks having LBAs 10 to 29. If a trailing logical sector arises in physical sector 109 in a situation where the number of leading logical sectors is zero, the logical sector to be written in physical sector 109 and the logical sector to be maintained arise. Therefore, it is necessary to read data blocks written in the eight logical sectors in physical sector 109 and preset a format for physical sector 109. The procedure to be performed to achieve such a purpose will be explained when steps 217 and beyond, which are performed if the judgment result obtained in step 205 indicates that the number of leading logical sectors is not zero, are described. If neither leading logical sectors nor trailing logical sectors arise, the present embodiment need not be used because the write data block can be directly written on the magnetic disk in the unit of a physical sector.

If the judgment result obtained in step 205 indicates that the number of leading logical sectors is not zero, processing proceeds to step 211. In step 211, the input/output control section 15 acquires an address space having extra addresses #004 and #005 in the sector buffer 17 in accordance with the number of leading logical sectors beginning with the FIFO address (#004), decides that address #006 is the storage start position for the first data set (LBA 10), and informs the input/output control section 15 of the decision. The input/output control section 15 stores a write data set, which is generated from the write data block 101, beginning with an address that is obtained by adding the number of extra addresses to the FIFO address. In compliance with instructions from the MPU 21, the input/output control section 15 also acquires in the sector buffer 17 an address spacing having extra addresses #026 and #027 after address #025 at which the last data set is to be stored in accordance with the number of trailing logical sectors (LBAs 30 and 31) succeeding the last logical sector (LBA 29). Therefore, when the next data set to be stored in the sector buffer 17 arises, the input/output control section 15 stores such a data set beginning with address #28.

In step 213, the read channel 31 reads all the logical sector data sets contained in physical sectors 107, 108, and 109 in which write data blocks (LBAs 10 to 29) are written, and sends them to the skip read section 29 as read data sets. One ECC is attached to a group of eight read data sets. The read data sets read from the read channel 31 are input into the skip read section 29 in the order of the leading data sets 103 (LBAs 08 and 09), discard data sets 104 (LBAs 10 to 29), and trailing data sets 105 (LBAs 30 and 31). The discard data sets are data sets that are read from a logical sector having an LBA of the write data block. The ECC circuit 25 performs an error correction process on each of the eight read data sets that are input into the skip read section 29. The ECC is later removed from the read data sets.

In step 215, the skip read section 29 discards the discard data sets 104 (LBAs 10 to 29) specified by the MPU 21, and outputs the leading data sets 103 (LBAs 08 and 09) and trailing data sets 105 (LBAs 30 and 31). Since the magnetic disk drive 10 can read data blocks in the unit of a physical sector, the data blocks in physical sector 108, which does not contain the leading data sets 103 or trailing data sets 105, need not always be read. In a normal read operation that differs from the above read operation for setting physical sector data sets for a write, the skip read section 29 outputs all the input data sets to the input/output control section 15 without discarding them.

In step 217, the input/output control section 15 stores the leading data sets 103 at extra addresses #04 and #05 of the sector buffer 17. In step 219, the input/output control section 15 stores the trailing data sets 105 at extra addresses #026 and #027 of the sector buffer 17. As a result, the data sets (LBAs 08 to 31) for a write, which are made of the write data set and a part of the read data set, are arranged in the sector buffer 17 in the order according to the formats of physical sectors 107, 108, and 109. The leading data sets 103 and trailing data sets 105 have been written on the magnetic disk 39. The write data set is generated from a data block that has been transferred from the host device 11.

In step 221, the input/output control section 15 reads 24 data sets from addresses #004 to #027 of the sector buffer 17, combines them with incidental information to formulate the formats of physical sectors 107, 108, and 109, and sends the resulting formats to the write channel 33 to conclude the write process for the write data block 101. In this instance, the data blocks are read from the sector buffer 17 in the order of addresses. Therefore, a high-speed data write process can be performed. Further, the use of the skip read section 29 makes it possible to formulate in the sector buffer 17 the data sets, which are arranged in the order of the leading data sets, write data sets, and trailing data sets, from the read data sets (LBAs 08 to 31), which are read through a single access without causing a rotational delay of the magnetic disk.

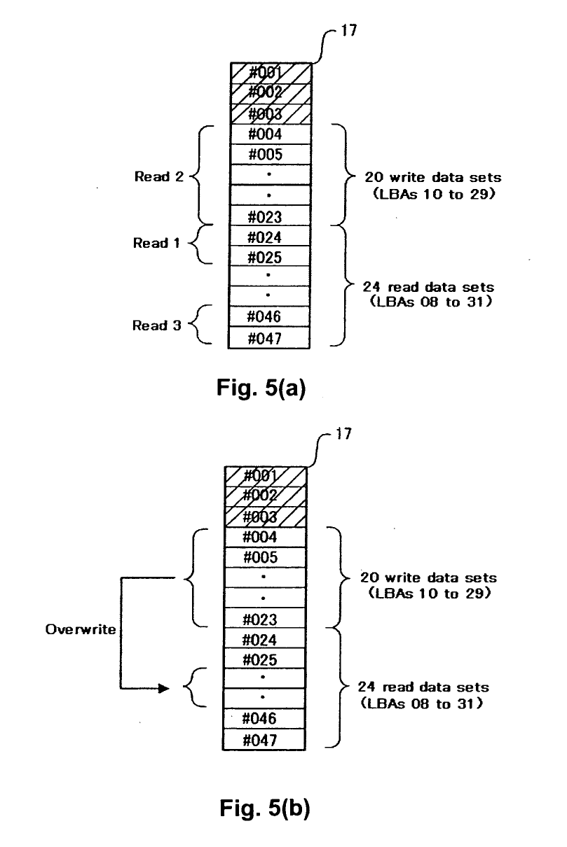

The method for writing the data block 101 described with reference to FIG. 3 in physical sectors 107, 108, and 109 without acquiring extra addresses for the physical sectors will now be described with reference to FIGS. 5(A) and 5(B). When no extra address is acquired for the sector buffer 17, the twenty write data sets are stored at addresses between the FIFO address (#004) and address #023 as shown in FIG. 5(A). The twenty-four read data sets that are read from physical sectors 107, 108, and 109, which contain a logical sector having the LBA of the write data set, are stored in the sector buffer 17 at addresses #024 to address #047. Alternatively, only the data sets in physical sectors 107 and 109, in which a leading logical sector or trailing logical sector arises, may be read from the magnetic disk and stored at unoccupied addresses of the sector buffer 17.

To formulate the formats of physical sectors 107, 108, and 109 and write data blocks on the magnetic disk 39, it is necessary that the data sets to be read from the sector buffer 17 be arranged in the order of the leading data sets, write data sets, and trailing data sets as described with reference to FIG. 3. The above purpose can be achieved when the input/output control section 15 or MPU 21 manages the write data set addresses in the sector buffer 17 and the read data set addresses, and sequentially reads them. In this instance, the leading read data sets stored at addresses #024 and #025 are first read, then the write data sets at addresses #04 to #023 are read, and finally the trailing read data sets stored at addresses #046 and #047 are read. If the write data sets and read data sets have the same LBAs, the write data sets are preferentially read.

The above purpose can also be achieved when twenty write data sets (LBAs 10 to 29) are overwritten in the sector buffer 17 at addresses at which the read data sets having the same LBAs are stored, as shown in FIG. 5(B), and the leading data sets, write data sets, and trailing data sets are arranged in the sector buffer 17 in the order of logical sectors. More specifically, the leading data sets, write data sets, and trailing data sets can be arranged in the sector buffer 17 in the order named by first storing the write data sets at sector buffer addresses #004 to #023 and then overwriting the write data sets at addresses #026 to #045.

Embodiments of the present invention have been described with reference to a magnetic disk drive. However, the present invention can be applied to a DVD storage device, magnetooptical disk drive, and other rotating disk storage devices in which the format of a physical sector differs from that of a logical sector. While the present invention has been described in conjunction with specific embodiments that are illustrated in the accompanying drawings, it is not limited to the embodiments illustrated in the drawings. Persons of skill in the art will appreciate that the present invention can be applied to any known configuration as far as it provides the advantages of the present invention.

What is claimed is:

1. A rotating disk storage device for recording a write data block containing a first data block and a last data block in the unit of a physical sector in a situation where a logical sector address is specified by a host device, the rotating disk storage device comprising:
a rotating disk recording medium on which a physical sector including a plurality of logical sectors is formatted;
a buffer for storing the write data block transferred from the host device and a leading data block recorded in a leading logical sector that is read from the physical sector containing a first logical sector for recording the first data block and positioned before the first logical sector; and
control means for controlling the buffer so that the first data block and the write data block are arranged in the buffer in the order of recording in the physical sector.

2. The rotating disk storage device according to claim 1, wherein the control means acquires an extra address before an address of the buffer at which the first data block is stored.

3. The rotating disk storage device according to claim 1, wherein the buffer is read by a physical sector containing a last logical sector that records the last data block and stores a trailing data block recorded in a trailing logical sector that is positioned after the last logical sector; and wherein the control means controls the buffer so that the leading data block, the write data block, the trailing data block are arranged in the buffer in the order of storing in the physical sector.

4. The rotating disk storage device according to claim 3, wherein the control means acquires an extra address after an address of the buffer at which the last data block is stored.

5. The rotating disk storage device according to claim 1, wherein the control means includes a skip read section that discards a data block that is among the data blocks read from the physical sector and assigned the same address as the write data block.

6. The rotating disk storage device according to claim 1, wherein the data block has an ECC for logical sector data blocks constituting the physical sector.

7. The rotating disk storage device according to claim 1, wherein the buffer stores a data set that is a set of the data block and a CRCC.

8. The rotating disk storage device according to claim 1, wherein the buffer stores a data block read from a physical sector containing a logical sector in which the write data block is recorded; and wherein the control means overwrites a write data block stored in the buffer at an address of the buffer at which a read data block having the same LBA as the write data block is stored.

9. A recording method for recording a write data block containing a first data block and a last data block in a storage device including a rotating disk recording medium on which a physical sector containing a plurality of logical sectors is formatted in a situation where a logical sector address is specified by a host device, the recording method comprising the steps of:
reading a data block from the physical sector containing a logical sector whose address is specified by the host device and generating a read data block;
arranging a leading data block recorded in a leading logical sector that precedes a logical sector in which the first data block is recorded and the write data block in a buffer in the order of recording in the physical sector; and
reading the leading data block and the write data block from the buffer and writing the leading data block and the write data block on the rotating disk recording medium.

10. The recording method according to claim 9, wherein the step of arranging in order includes the step of acquiring an extra address before an address of the buffer at which the first data block is stored.

11. The recording method according to claim 9, wherein the step of arranging in order includes the step of arranging the leading data block, the write data block, and a trailing data block recorded in a trailing logical sector that follows a logical sector in which the last data block is recorded in the buffer in the order of recording in the physical sector.

12. The recording method according to claim 11, wherein the step of arranging in order includes the step of acquiring an extra address after an address of the buffer at which the last data block is stored.

13. The recording method according to claim 12, further comprising the step of:
storing a data block transferred from the host device subsequently to the write data block at an address that succeeds the extra address.

14. The recording method according to claim 9, wherein the step of generating the read data block includes the step of reading a data block from only a physical sector that records the first data block and the last data block.

15. The recording method according to claim 9, wherein the step of arranging in order includes the step of discarding a read data block having the same address as the write data block.

16. The recording method according to claim 9, wherein the step of arranging in order includes the step of overwriting the write data block stored in the buffer at an address of the buffer at which the read data block having the same LBA as the write data block is stored.

17. The recording method according to claim 9, wherein the step of recording includes the step of generating an ECC in the unit of a physical sector.

18. A rotating disk storage device for recording a data block whose logical sector address is specified by a host device in the unit of a physical sector, the rotating disk storage device comprising:
a rotating disk recording medium on which a physical sector including a plurality of logical sectors is formatted;
a buffer for storing a write data block transferred from the host device and a read data block that is read from the physical sector containing a logical sector whose address is specified by the host device; and
read means for reading the write data block and the read data block from the buffer in the order of recording in the physical sector while giving priority to the write data block when the address of the write data block is the same as the address of the read data block.
